(19) United States
(12) Patent Application Publication
(10) Pub. No.: US 2023/0171724 A1
(43) Pub. Date: Jun. 1, 2023

(54) System Information Design For Synchronization In Non-Terrestrial Network Communications

(71) Applicant: MediaTek Singapore Pte. Ltd., Singapore (SG)

(72) Inventors: Abdelkader Medles, Cambridge (GB); Mehmet Kunt, Cambridge (GB); Gilles Charbit, Cambridge (GB); Pradeep Jose, Cambridge (GB)

(21) Appl. No.: 17/922,113

(22) PCT Filed: Apr. 28, 2021
(86) PCT No.: PCT/CN2021/090655

§ 371 Date: Oct. 28, 2022

Related U.S. Application Data
(60) Provisional application No. 63/016,342, filed on Apr. 28, 2020.

(51) Int. Cl. H04W 56/00; H04B 7/185; H04W 76/27

(52) U.S. Cl. CPC H04W 56/004; H04B 7/18513; H04W 56/0015; H04W 76/27

(57) ABSTRACT

Various solutions for system information design for synchronization in non-terrestrial network (NTN) communications are described. An apparatus (e.g., a UE) receives synchronization information from a wireless network. Using the synchronization information, the apparatus maintains synchronization in performing NTN communications with the wireless network.

### CROSS REFERENCE TO RELATED PATENT APPLICATION(S)

The present disclosure is part of U.S. National Stage filing of International Patent Application No. PCT/CN2021/090631, filed on 28 Apr. 2021, which is part of a non-provisional application claiming the priority benefit of U.S. Patent Application No. 63/016,342, filed on 28 Apr. 2020, the contents of which being incorporated by reference in their entirety.

### TECHNICAL FIELD

The present disclosure is generally related to mobile communications and, more particularly, to system information design for synchronization in non-terrestrial network (NTN) communications.

### BACKGROUND

Unless otherwise indicated herein, approaches described in this section are not prior art to the claims listed below and are not admitted as prior art by inclusion in this section.

In NTN communications, in order to compensate for propagation delay and Doppler shift in wireless communications over a link, a user equipment (UE) needs to be aware of certain information. For example, the UE needs to know its UE position (e.g., via Global Navigation Satellite System (GNSS) positioning or a known position), the position and velocity of a satellite (or other flying object(s)) functioning as part of the NTN communications, and a time reference with respect to the position and velocity of the satellite. In case the satellite is a reference point, there would be no need for the UE to obtain information on a feeder link between a land-based network node (e.g., base station) and the satellite. In case the propagation delay includes the feeder, the UE would need to know either the position of the land-based network node or information related to the feeder link (e.g., feeder link delay and delay drift rate). In case there is switching delay due to processing at the satellite, the UE would also need to know the switching delay. For synchronization in the NTN communications, synchronization information needs to be signaled to the UE. However, there are some issues that need to be addressed. Such issues include, for example, how efficient the signaling to the UE is to be optimized, how the UE is to propagate the information to maintain synchronization, and when the UE is to receive the synchronization information.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues. More specifically, various schemes proposed in the present disclosure are believed to address issues pertaining to system information for synchronization in NTN communications.

In one aspect, a method may involve an apparatus receiving synchronization information from a wireless network. The method may also involve the apparatus maintaining synchronization using the synchronization information in performing NTN communications with the wireless network.

In another aspect, a method may involve an apparatus receiving synchronization information from a wireless network and maintaining synchronization using the synchronization information in performing NTN communications with the wireless network. The method may also involve storing the synchronization information. The method may further involve refreshing the stored synchronization information with new synchronization information subsequently received from the wireless network.

In yet another aspect, an apparatus may include a transceiver and a processor coupled to the transceiver. The transceiver may be configured to wirelessly communicate with a wireless network. The processor may be configured to receive, via the transceiver, synchronization information from the wireless network. The processor may also maintain, via the transceiver, synchronization using the synchronization information in performing NTN communications with the wireless network.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT), Narrow Band Internet of Things (NB-IoT), Industrial Internet of Things (IIoT) and non-terrestrial network (NTN), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication apparatus and an example network apparatus in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to system information design for synchronization in NTN communications. According to the present disclosure, a number of possible solutions may be implemented separately or jointly. That is, although these possible solutions may be described below separately, two or more of these possible solutions may be implemented in one combination or another.

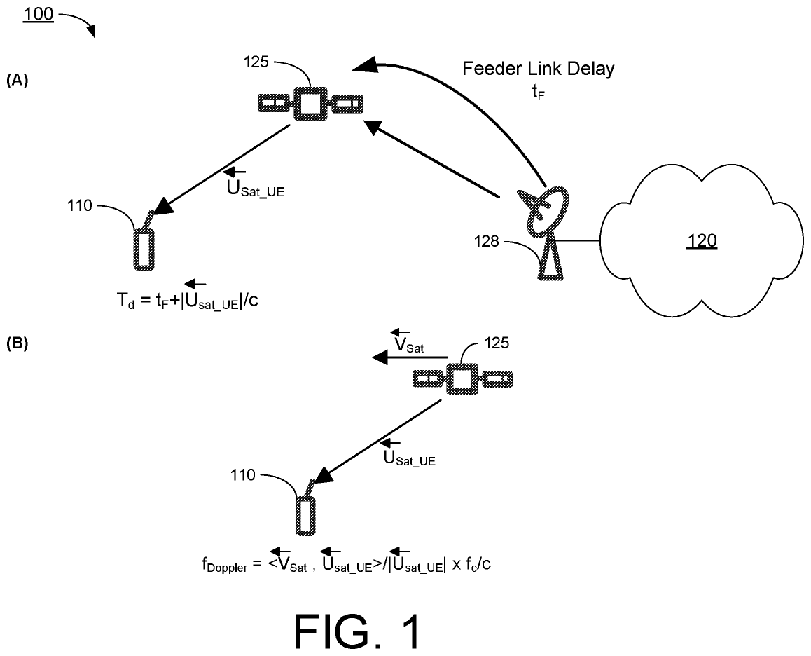

FIG. 1 illustrates an example network environment 100 in which various proposed schemes in accordance with the present disclosure may be implemented. Network environment 100 may involve a UE 110 and a wireless network 120 (e.g., an LTE network, a 5G network, an NR network, an IoT network, an NB-IoT network, an IIoT network or an NTN network). UE 110 may communicate with wireless network 120 via a non-terrestrial (NT) network node 125 (e.g., a satellite) and/or a terrestrial network node 128 (e.g., a gateway, base station, eNB, gNB or transmission/reception point (TRP)). Referring to part (A) and part (B) of FIG. 1, NT network node 125 may be moving at a speed of Vₛₐₜ with a relative motion/velocity of U_{sat_UE} with respect to UE 110, and there may be a feeder link delay t_{F} associated with the feeder link between terrestrial network node 128 and NT network node 125. Correspondingly, a propagation delay Td and a Doppler shift f_{Doppler} may result. In FIG. 1, f_{c} denotes the frequency of a carrier signal and c denotes the speed of light. Under various proposed schemes in accordance with the present disclosure, each of UE 110, NT network node 125 and terrestrial network node 128 may be configured to perform operations pertaining to system information design for synchronization in NTN communications, as described below.

Under a first proposed scheme in accordance with the present disclosure, synchronization information (e.g., position, velocity, time, gateway information and/or feeder link delay) may be broadcast by wireless network 120 in a system information block (SIB). In an event that the SIB is an existing SIB, the synchronization information may be added to an information element (IE) definition for the existing SIB. In an event that the SIB is a new SIB, a new IE may be defined for the new SIB that includes the synchronization information.

Under the proposed scheme, UE 110 may acquire and apply the synchronization information either upon every reception of a SIB containing the synchronization information or only when explicitly indicated by wireless network 120. In an event that UE 110 applies the synchronization information upon every reception of a SIB containing the synchronization information, UE 110 may store the received synchronization information and refresh it every time UE 110 acquires another transmission of the SIB from wireless network 120. For instance, UE 110 may consider the stored synchronization information as invalid and may replace the stored synchronization information with the new synchronization information contained in a subsequently received SIB. Under the proposed scheme, a validity timer may be utilized and the duration of the validity timer may be fixed (e.g., defined in a pertinent 3GPP specification such as Release 16 of the 3GPP specification), configured by radio resource control (RRC) signaling from wireless network 120, indicated in the SIB separately, or indicated as part of the synchronization information.

In an event that UE 110 applies the synchronization information when explicitly indicated by wireless network 120, a change in the SIB content may be indicated explicitly in the SIB (e.g., by toggling one bit in the SIB) as a way to instruct UE 110 to apply the synchronization information contained in the respective SIB. Accordingly, upon reception of the SIB containing the synchronization information, UE 110 may apply the synchronization information when the indication bit is toggled (e.g., when its value is set to “1”).

Under the proposed scheme, UE 110 may acquire the SIB with synchronization information at various times. For instance, UE 110 may acquire the SIB with synchronization information prior to a paging occasion. Alternatively, or additionally, UE 110 may acquire the SIB with synchronization information following a paging message. Alternatively, or additionally, UE 110 may acquire the SIB with synchronization information prior to a random access channel (RACH) transmission.

Under the proposed scheme, upon successful acquisition of the SIB with synchronization information, UE 110 may apply the received synchronization information indicated in the SIB (e.g., position, velocity, time, gateway information). The synchronization information may be used by UE 110 in all RRC states or modes including, for example and without limitation, an idle mode (e.g., RRC_IDLE), a connected mode (e.g., RRC_CONNECTED), and an inactive mode (e.g., RRC_INACTIVE) (in NR). While in the RRC_CONNECTED mode, UE 110 may perform monitoring and acquisition of the SIB with synchronization information. For NB-IoT, a change in UE behavior may be required. In Release 15 (Rel-15) of the 3GPP specification, a NB-IoT UE does not acquire the system information in RRC_CONNECTED mode while a timer T311 is not running. As an option, wireless network 120 may provide the synchronization information to UE 110 via a dedicated signaling. For instance, wireless network 120 may provide the synchronization information to UE 110 within an RRCConnectionReconfiguration message or an RRCReconfiguration message. It is noteworthy that the option of using a dedicated RRC message to provide the synchronization information to UE 110 may be as alternative or in addition to providing the synchronization information in an SIB (e.g., by broadcast). Under the proposed scheme, in case UE 110 is unable to acquire the SIB with synchronization information (and for an NTN cell), UE 110 may consider the cell as barred and, accordingly, may bar the cell for a predetermined period. Alternatively, or additionally, UE 110 may return to RRC_IDLE mode in case UE 110 was in RRC_CONNECTED mode or RRC_INACTIVE mode (in NR) and then perform cell reselection.

Under the proposed scheme, content of the synchronization information may include position, velocity and time (PVT) information, with the time information being implicit with reference to the SIB transmission time or explicitly signaled. In case no velocity is signaled, UE 110 may still calculate the velocity by: (1) approximating velocity to a difference between the satellite position (e.g., position of NT network node 125) of adjacent times and (2) correcting for gravity and air drag as follows: \vec{Vₜ}˜(\vec{S_{t+Δ}}−\vec{Sₜ})/Δ−Δ/2·\vec{gₜ}. Optionally, the content of the synchronization information may also include gateway information such as, for example and without limitation, gateway position (e.g., position of terrestrial network node 128), feeder link delay, and feeder link delay drift rate. Optionally, the content of the synchronization information may also include air draft coefficient. Optionally, the content of the synchronization information may also include satellite identifier (ID) and synchronization information group ID. For instance, in case UE 110 moves to a different cell with the same satellite ID and/or group ID, and in case the stored synchronization information is still valid (e.g., within a valid time/duration of the validity timer), then UE 110 may ignore a new SIB containing synchronization information. Optionally, the content of the synchronization information may also include a validity time for the validity timer.

Under a second proposed scheme in accordance with the present disclosure, a format of the synchronization information may be designed to cater to different scenarios. For instance, one scenario may be that satellite velocity is large. Another scenario may be that satellite is fixed and/or Doppler is negligible and hence there would be no need for velocity signaling. Yet another scenario may be that a propagation delay includes the feeder link. Still another scenario may be that a timer reference point is the satellite and hence there would be no need for signaling about the feeder link delay and/or gateway location.

Under the proposed scheme, the different scenarios may be distinguished depending on whether the velocity of satellite (e.g., NT network node 125) is signaled. For instance, in case the synchronization information does not contain velocity information, UE 110 may assume that the satellite is slowly moving and that Doppler is zero or very small (e.g., negligible) with no need for pre-compensation. In case the synchronization information does not contain feeder link information, UE 110 may assume that the time reference point is the satellite (e.g., NT network node 125) and no feeder link delay compensation would be required.

### Illustrative Implementations

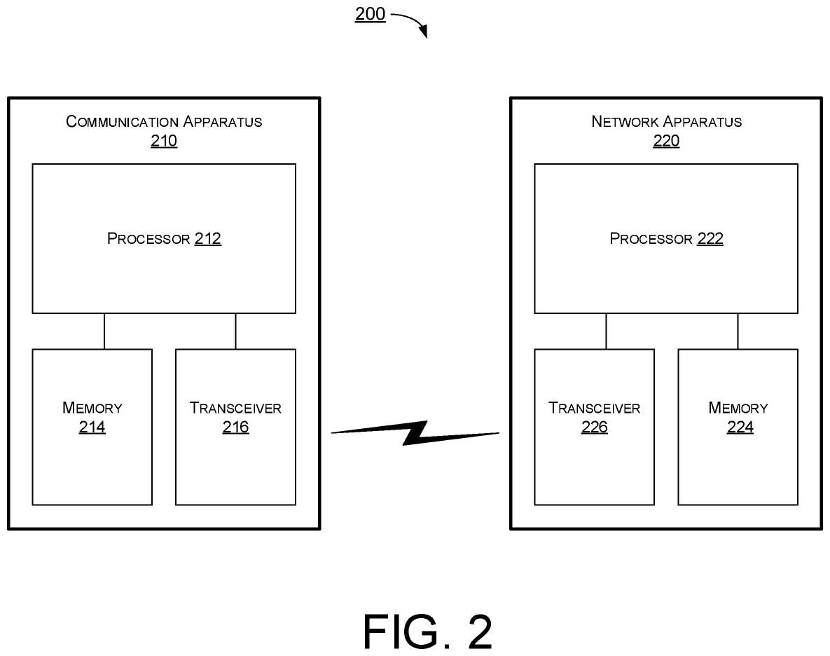

FIG. 2 illustrates an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to system information design for synchronization in NTN communications, including scenarios/schemes described above as well as processes 300, 400 and 500 described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus/station, which may be a network node such as a base station, a small cell, a router, a gateway or a satellite. For instance, network apparatus 220 may be implemented in an eNodeB in an LTE, in a gNB in a 5G, NR, IoT, NB-IoT, IIoT, or in a satellite in an NTN network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including power consumption reduction in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively.

Each of communication apparatus 210 and network apparatus 220 may be a communication entity capable of communicating with each other using various proposed schemes in accordance with the present disclosure. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE (e.g., UE 110) and network apparatus 220 is implemented in or as a network node or base station (e.g., NT network node 125 or terrestrial network node 128) of a communication network (e.g., network 120). It is also noteworthy that, although the example implementations described below are provided in the context of NTN communications, the same may be implemented in other types of networks.

Under a proposed scheme pertaining to system information design for synchronization in NTN communications in accordance with the present disclosure, with communication apparatus 210 implemented in or as UE 110 and network apparatus 220 implemented in or as NT network node 125 or terrestrial network node 128 in network environment 100, processor 212 of communication apparatus 210 may receive synchronization information from a wireless network (e.g., network 120) via apparatus 220 (e.g., as NT network node 125 or terrestrial network node 128). Additionally, processor 212 may maintain, via transceiver 216, synchronization using the synchronization information in performing NTN communications with the wireless network.

In some implementations, the synchronization information, which may be valid at a time reference, may include at least some or all of the following: a position of a non-terrestrial network node, a velocity of the non-terrestrial network node, a feeder link delay, a feeder link delay drift rate, and a switching delay.

In some implementations, in receiving the synchronization information, processor 212 may receive a SIB containing the synchronization information prior to a paging occasion.

Alternatively, or additionally, in receiving the synchronization information, processor 212 may receive a SIB containing the synchronization information following a paging message.

Alternatively, or additionally, in receiving the synchronization information, processor 212 may receive a SIB containing the synchronization information prior to a RACH transmission.

In some implementations, in receiving the synchronization information, processor 212 may receive the synchronization information via a dedicated signaling within a RRC message such as a RRC connection reconfiguration (RRCConnectionReconfiguration) message or a RRC reconfiguration (RRCReconfiguration) message.

In some implementations, in receiving the synchronization information, processor 212 may perform certain operations. For instance, processor 212 may acquire a SIB containing the synchronization information. Additionally, processor 212 may receive the SIB containing the synchronization information from the wireless network. Moreover, in response to not receiving any SIB with the synchronization information from a cell, processor 212 may perform the following: (a) determining the cell as being barred; and (b) returning to a RRC idle (RRC_IDLE) mode from a RRC connected (RRC_CONNECTED) mode or a RRC inactive (RRC_INACTIVE) mode. In some implementations, the cell may be barred for a predetermined period after which processor 212 may consider the cell being available and not barred.

In some implementations, processor 212 may perform additional operations. For instance, processor 212 may store, in memory 214, the synchronization information. Moreover, processor 212 may refresh the stored synchronization information with new synchronization information subsequently received from the wireless network.

In some implementations, in refreshing the stored synchronization information, processor 212 may perform certain operations. For instance, processor 212 may determine the status of a validity timer. Moreover, processor 212 may perform either of the following: (a) in response to the validity timer having expired, refreshing the stored synchronization information with the new synchronization information (e.g., by re-acquiring the SIB with the synchronization information); or (b) in response to the validity timer being running, continuing to use the stored synchronization information without refreshing the stored synchronization information with the new synchronization information.

In some implementations, a duration of the validity timer may be fixed. Alternatively, the duration of the validity timer may be configured by a RRC signaling from the wireless network. Alternatively, the duration of the validity timer may be separately indicated in a SIB which contains the synchronization information. Alternatively, the duration of the validity timer may be indicated in a SIB as a part of the synchronization information.

### Illustrative Processes

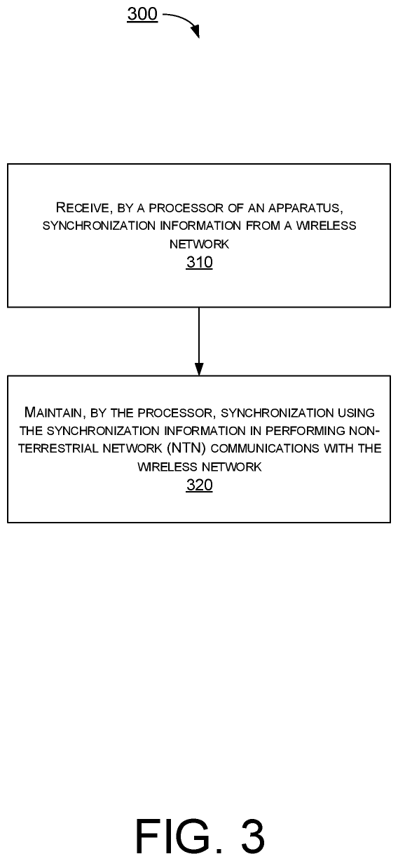

FIG. 3 illustrates an example process 300 in accordance with an implementation of the present disclosure. Process 300 may be an example implementation of schemes described above, whether partially or completely, with respect to system information design for synchronization in NTN communications in accordance with the present disclosure. Process 300 may represent an aspect of implementation of features of communication apparatus 210. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210 and network apparatus 220. Process 300 may begin at block 310.

At 310, process 300 may involve processor 212 of communication apparatus 210 receiving, via transceiver 216, synchronization information from a wireless network (e.g., network 120). Process 300 may proceed from 310 to 320.

At 320, process 300 may involve processor 212 maintaining, via transceiver 216, synchronization using the synchronization information in performing NTN communications with the wireless network.

In some implementations, the synchronization information may include at least some or all of the following: a time reference with respect to a position and a velocity of a non-terrestrial network node, a feeder link delay, a feeder link delay drift rate, and a switching delay.

In some implementations, in receiving the synchronization information, process 300 may involve processor 212 receiving a SIB containing the synchronization information prior to a paging occasion.

Alternatively, or additionally, in receiving the synchronization information, process 300 may involve processor 212 receiving a SIB containing the synchronization information following a paging message.

Alternatively, or additionally, in receiving the synchronization information, process 300 may involve processor 212 receiving a SIB containing the synchronization information prior to a RACH transmission.

In some implementations, in receiving the synchronization information, process 300 may involve processor 212 receiving the synchronization information via a dedicated signaling within a RRC message such as a RRC connection reconfiguration (RRCConnectionReconfiguration) message or a RRC reconfiguration (RRCReconfiguration) message.

In some implementations, in receiving the synchronization information, process 300 may involve processor 212 performing certain operations. For instance, process 300 may involve processor 212 acquiring a SIB containing the synchronization information. Additionally, process 300 may involve processor 212 receiving the SIB containing the synchronization information from the wireless network. Moreover, in response to not receiving any SIB with the synchronization information from a cell, process 300 may involve processor 212 performing the following: (a) determining the cell as being barred; and (b) returning to a RRC idle (RRC_IDLE) mode from a RRC connected (RRC_CONNECTED) mode or a RRC inactive (RRC_INACTIVE) mode. In some implementations, the cell may be barred for a predetermined period after which processor 212 may consider the cell being available and not barred.

In some implementations, process 300 may involve processor 212 performing additional operations. For instance, process 300 may involve processor 212 storing, in memory 214, the synchronization information. Moreover, process 300 may involve processor 212 refreshing the stored synchronization information with new synchronization information subsequently received from the wireless network.

In some implementations, in refreshing the stored synchronization information, process 300 may involve processor 212 performing certain operations. For instance, process 300 may involve processor 212 determining the status of a validity timer. Moreover, process 300 may involve processor 212 performing either of the following: (a) in response to the validity timer having expired, refreshing the stored synchronization information with the new synchronization information (e.g., by re-acquiring the SIB with the synchronization information); or (b) in response to the validity timer being running, continuing to use the stored synchronization information without refreshing the stored synchronization information with the new synchronization information.

In some implementations, a duration of the validity timer may be fixed. Alternatively, the duration of the validity timer may be configured by a RRC signaling from the wireless network. Alternatively, the duration of the validity timer may be separately indicated in a SIB which contains the synchronization information. Alternatively, the duration of the validity timer may be indicated in a SIB as a part of the synchronization information.

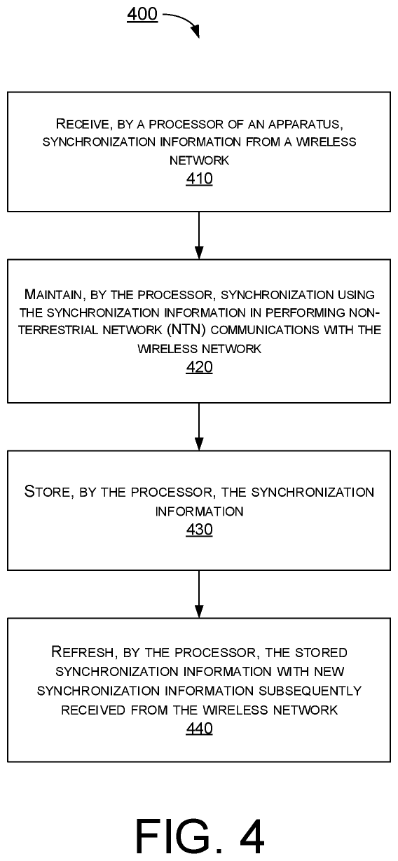

FIG. 4 illustrates an example process 400 in accordance with an implementation of the present disclosure. Process 400 may be an example implementation of schemes described above, whether partially or completely, with respect to system information design for synchronization in NTN communications in accordance with the present disclosure. Process 400 may represent an aspect of implementation of features of communication apparatus 210. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 210 or any suitable UE or machine type devices. Solely for illustrative purposes and without limitation, process 400 is described below in the context of communication apparatus 210 and network apparatus 220. Process 400 may begin at block 410.

At 410, process 400 may involve processor 212 of communication apparatus 210 receiving, via transceiver 216, synchronization information from a wireless network (e.g., network 120). Process 400 may proceed from 410 to 420.

At 420, process 400 may involve processor 212 maintaining, via transceiver 216, synchronization using the synchronization information in performing NTN communications with the wireless network. Process 400 may proceed from 420 to 430.

At 430, process 400 may involve processor 212 storing the synchronization information. Process 400 may proceed from 430 to 440.

At 440, process 400 may involve processor 212 refreshing the stored synchronization information with new synchronization information subsequently received from the wireless network.

In some implementations, in refreshing the stored synchronization information, process 400 may involve processor 212 performing certain operations. For instance, process 400 may involve processor 212 determining a status of a validity timer. Additionally, process 400 may involve processor 212 performing either: (a) refreshing the stored synchronization information with the new synchronization information in response to the validity timer having expired; or (b) continuing to use the stored synchronization information without refreshing the stored synchronization information with the new synchronization information in response to the validity timer being running.

In some implementation, a duration of the validity timer may be fixed.

In some implementation, a duration of the validity timer may be configured by an RRC signaling from the wireless network.

In some implementation, a duration of the validity timer may be separately indicated in a SIB which contains the synchronization information.

In some implementation, a duration of the validity timer may be indicated in a SIB as a part of the synchronization information.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
receiving, by a processor of an apparatus, synchronization information from a wireless network; and
maintaining, by the processor, synchronization using the synchronization information in performing non-terrestrial network (NTN) communications with the wireless network,
wherein the synchronization information, which is valid at a time reference, comprises some or all of:
a position of a non-terrestrial network node,
a velocity of the non-terrestrial network node,
a feeder link delay,
a feeder link delay drift rate, and
a switching delay.

2. The method of claim 1, wherein the receiving of the synchronization information comprises acquiring a system information block (SIB) containing the synchronization information.

3. The method of claim 2, wherein the receiving of the synchronization information comprises receiving the SIB containing the synchronization information prior to a paging occasion.

4. The method of claim 2, wherein the receiving of the synchronization information comprises receiving the SIB containing the synchronization information following a paging message.

5. The method of claim 2, wherein the receiving of the synchronization information comprises receiving the SIB containing the synchronization information prior to a random access channel (RACH) transmission.

6. The method of claim 2, wherein the receiving of the synchronization information further comprises:
responsive to not receiving any SIB with the synchronization information from a cell, determining the cell as being barred; and
returning to a radio resource control (RRC) idle (RRC_IDLE) mode from a RRC connected (RRC_CONNECTED) mode or a RRC inactive (RRC_INACTIVE) mode.

7. The method of claim 6, wherein the cell is barred for a predetermined period.

8. The method of claim 1, wherein the receiving of the synchronization information comprises receiving the synchronization information via a dedicated signaling within a radio resource control (RRC) message.

9. The method of claim 1, further comprising:
storing, by the processor, the synchronization information; and
refreshing, by the processor, the stored synchronization information with new synchronization information subsequently received from the wireless network.

10. A method, comprising:
receiving, by a processor of an apparatus, synchronization information from a wireless network;
maintaining, by the processor, synchronization using the synchronization information in performing non-terrestrial network (NTN) communications with the wireless network;
storing, by the processor, the synchronization information; and
refreshing, by the processor, the stored synchronization information with new synchronization information subsequently received from the wireless network,
wherein the refreshing of the stored synchronization information comprises:
determining a status of a validity timer; and
either:
responsive to the validity timer having expired, refreshing the stored synchronization information with the new synchronization information; or
responsive to the validity timer being running, continuing to use the stored synchronization information without refreshing the stored synchronization information with the new synchronization information.

11. The method of claim 10, wherein a duration of the validity timer is fixed.

12. The method of claim 10, wherein a duration of the validity timer is configured by a radio resource control (RRC) signaling from the wireless network.

13. The method of claim 10, wherein a duration of the validity timer is separately indicated in a system information block (SIB) which contains the synchronization information.

14. The method of claim 10, wherein a duration of the validity timer is indicated in a system information block (SIB) as a part of the synchronization information.

15. An apparatus, comprising:
a transceiver configured to wirelessly communicate with a wireless network; and
a processor coupled to the transceiver and configured to perform operations comprising:
receiving, via the transceiver, synchronization information from the wireless network; and
maintaining, via the transceiver, synchronization using the synchronization information in performing non-terrestrial network (NTN) communications with the wireless network,
wherein the synchronization information valid at a time reference comprises some or all of:
a position of a non-terrestrial network node,
a velocity of a non-terrestrial network node,
a feeder link delay,
a feeder link delay drift rate, and
a switching delay.

16. The apparatus of claim 15, wherein, in receiving the synchronization information, the processor acquires a system information block (SIB) containing the synchronization information.

17. The apparatus of claim 16, wherein, in receiving the synchronization information, the processor performs one of:
receiving the SIB containing the synchronization information prior to a paging occasion;
receiving the SIB containing the synchronization information following a paging message; or
receiving the SIB containing the synchronization information prior to a random access channel (RACH) transmission.

18. The apparatus of claim 16, wherein, in receiving the synchronization information, the processor performs operations comprising:
responsive to not receiving any SIB with the synchronization information from a cell, determining the cell as being barred; and
returning to a radio resource control (RRC) idle (RRC_IDLE) mode from a RRC connected (RRC_CONNECTED) mode or a RRC inactive (RRC_INACTIVE) mode,
wherein the cell is barred for a predetermined period.

19. The apparatus of claim 15, wherein, in receiving the synchronization information, the processor receives the synchronization information via a dedicated signaling within a radio resource control (RRC) message.

20. The apparatus of claim 15, wherein the processor is configured to further perform operations comprising:
storing the synchronization information; and
refreshing the stored synchronization information with new synchronization information subsequently received from the wireless network by:
determining a status of a validity timer; and
either:
responsive to the validity timer having expired, refreshing the stored synchronization information with the new synchronization information; or
responsive to the validity timer being running, continuing to use the stored synchronization information without refreshing the stored synchronization information with the new synchronization information,
wherein a duration of the validity timer is fixed, configured by a radio resource control (RRC) signaling from the wireless network, separately indicated in a system information block (SIB) which contains the synchronization information, or indicated in a system information block (SIB) as a part of the synchronization information.
